(19) United States
(12) Patent Application Publication
(10) Pub. No.: US 2006/0179420 A1
(43) Pub. Date: Aug. 10, 2006

(54) Web VPCL (web visual plan construct language: a visual system and method for learning and teaching programming and problem solving)

(76) Inventor: Alireza Ebrahimi, Mineola, NY (US)

Correspondence Address: ALIREZA EBRAHIMI, 51 JACKSON AVE., MINEOLA, NY, 11501, US

(21) Appl. No.: 11/319,092

(22) Filed: Dec. 22, 2005

Related U.S. Application Data
(60) Provisional application No. 60/638,446, filed on Dec. 22, 2004.

(51) Int. Cl. G06F 9/44

(52) U.S. Cl. 717/114

(57) ABSTRACT

The invention is a system and method used for teaching and learning computer programming. This system incorporates visualization, plan abstraction and its integration, and language constructs into one teaching and learning environment known as VPCL. There are three phases of VPCL, Plan Observation or Rehearsal, Plan Integration or Composition, and Plan Creation or Innovation. The observation Phase teaches how a program (plan) is broken down into smaller components known as a plan with their relationship. Each plan may further break down into smaller plans. At the last level plans are illustrated by language constructs. The integration phase concentrates on how plans are related to each other to build a program using the four methods of integration. The creation phase concentrates on how a new plan is created using the existing plans along with system resources. VPCL can be applied to other problem solving tasks such as mathematics, science, physics, chemistry, biology, or linguistics.

### BACKGROUND

Programming is still recognized as a difficult task and there has not been any successful change to improve and enhance learning and teaching of programming. It is estimated by the Department of Labor that by 2005 in the US alone, there will be more than 55 million End-User Developers (novices who need programming).

Based on my study of novice programmers and causes of errors, as my dissertation (Polytechnic University, New York 1989), I have designed a system known as Visual Plan Construct Language (VPCL), which incorporates visualization, plan abstraction and its integration, and language constructs into one teaching and learning environment.

Mismanagement of plans has been a major cause of errors, not just understanding of the constructs such as if, while, or other statements. I have published an article in the Journal of Visual Languages and Computing (1992), Academic Press, about how to use VPCL and its benefits for learning and teaching programming. However, I have not specified how this system can be designed and implemented manually (hand drawing, hand written, cards or blocks, puzzle, game) or can be implemented as a computer software. Web has given a new dimension to VPCL in regards to its usage and design principle. Moreover, by a letter to the editor of Communication of Association for Computing Machinery July, 2000 “Add PBE to Conventional Languages” I have addressed some of the serious issues that novice programmers and programming languages are facing. I have included my article on VPCL and the letter to the ACM as part of my support to this patent.

VPCL originally was implemented by HyperTalk and HyperCard in the Apple Macintosh environment; however, the software is recreated by HTML coding and JavaScript. Other similar tools such as Flash, FrontPage, Power Point, in conjunction with current programming languages such as C/C++, Visual Basic, and Java, Perl, and PHP can be useful as well to implement VPCL. In order to shift VPCL to the Internet so that it can be accessible world wide. CGI, ASP, or JSP would be some choices either on Apache Linux or IIS Windows servers.

### BRIEF SUMMARY OF THE INVENTION

A problem facing the technological field today is the difficulty of learning programming. Most people are intimidated by the word programming. When it comes to learning, the methods used nowadays may seem too complicated for a beginner. VPCL has incorporated all aspects of programming and programming languages. It is made to help novice programmers learning programming in easy ways. Another problem which has also arisen is that those who know programming do not understand correctly the concepts. Visual Plan Construct Language incorporates a visualization plan abstraction; its integration and language constructs into one integrated teaching and learning environment.

Mismanagement of plans has been a major cause of errors, not just understanding of the constructs such as “if” “while”, or other statements. Many problems with programming can be identified at an early stage and be corrected by training rather than at the end by trial and error. The invention creates a standard where the educator and learner can easily communicate with each other as to what has gone wrong and what steps are necessary to take to correct the problem.

VPCL effectiveness has been proven by empirical studies to improve learning of programming. Visualization is incorporated into all aspects of programming and programming languages. Pictures and, drawings can help user's visualization of a plan. Rather than memorizing a series of arcane programming language notations, a programmer can concentrate on plans, their relationship, and how they are coded. Any meaningful concept whether belonging to problem solving or programming statements can be a plan.

Programming by plans makes programming not a linear and textual entity anymore. Novice programmers will establish a standard as to what has gone wrong based on the plan error categorization. By visualization of plans, they easily visualize what is missing. While use of VPCL has been tested on novice programmers, VPCL can be used as a generic system and applied to other problem solving tasks such as mathematics, science (physics, chemistry, biology, etc.), or linguistics. The concept and program will remain the same, only the titles of the pages and contents will be changed.

### SUMMARY

Programming is still recognized as a difficult task for decades and there has not been any successful change to improve and enhance learning and teaching of programming.

The main object of the present invention is to provide a visual plan system and a method known as VPCL for teaching and learning programming.

Another objective of the invention is to provide programming literacy by making programming easy for everyone.

Another objective of VPCL is to reduce or eliminate programming errors both in syntax and logic.

Another objective is to enhance problem solving skills by promoting abstraction.

Another objective is to create a new program by using existing programs.

In order to accomplish the above objectives, VPCL incorporates visualization in all aspects of programming.

Visualization can be accomplished through various programming steps such as plan composition, language constructs, and program execution.

To understand and learn programming VPCL is divided into three phases introductory, intermediate and advanced.

During the plan observation or elementary level, the programming steps of a plan are rehearsed.

In the Intermediate level, the plans of a given problem are integrated and also tested by the user.

In the advanced level, all the programming steps are developed using and modifying preexisting plans or design from scratch and giving it a new plan name.

The effectiveness of VPCL as an instructional and developmental tool is demonstrated by the analysis of a sample empirical study which can be reexamined in different situations.

The invention has a library of a common problem set (plan) for novice programmers which include a statistical problem known as find average, find minimum, a search, and a sorting problem. In addition, a plan will address the language constructs of VPCL.

VPCL is not language dependent and can be adjusted to any of the current conventional languages.

The main form will have a library of the main plans in conjunction with the following teaching and learning phases. VPCL breaks teaching and learning into three layers or phases.

Phase 1, plan observation or rehearsal, is a training and observing phase for learning and teaching a problem to be solved.

Phase 2 focuses on the integration of plans. The idea behind this plan integration is to focus on the relationship between plans of a problem rather than how a plan is coded at the beginning. An educator or learner can hide unnecessary details which are overwhelming at the time and delay them until a proper time.

Phase 3, plan creation or innovation is the last step in VPCL. The Creation Phase creates a new plan based on an existing plan by modification. This phase deals with the creation of plans and writing actual programming code. In this final phase, the user will only be given a statement of the problem.

To solve the problem, the user will have to develop all of the steps required to arrive at a solution. These steps include selection and modification of available plans from the VPCL Library, integration of plans and their modification, and the execution of the program.

### BRIEF DESCRIPTION OF SEVERAL VIEWS OF THE DRAWINGS

FIG. 1 illustrates a library interface of common problem set (plans), find average plan, a search plan, sorting plan, language constructs plan, and payroll plan.

FIG. 2 is a screenshot illustrating some phases available after selecting the Find Average Plan.

FIG. 3 is a screenshot illustrating phase 1, Plan Observation, after selection from the find average plan.

FIG. 4 is a screenshot illustrating a predefined code for Compute Average Plan. (Mouse-over Plans to View Code)

FIG. 5 is a screenshot illustrating the Input Number Plan and Sum Number Plan when Interleaved. When plans are interleaved pictures and code are joined.

FIG. 6 is a screenshot illustrating code for Input and Sum Number Plan. (Mouse-over any Plan to View Code) Code is represented one after the other; a statement in Plan B is after a statement in Plan A and so on.

FIG. 7 is a screenshot demonstrating plan integration. (Interleaved)

FIG. 8 is a screenshot illustrating Code for Input, Sum, and Count Number Plan.

FIG. 9 is a screenshot demonstrating plan integration Input, Sum, and Count Number Plan which is appended with the Exception Plan.

FIG. 10 is a screenshot demonstrating a decision in the Exception Plan which branches the various options. (Branched)

FIG. 11 is a screenshot demonstrating Compute Average Plan appended with Display Average Plan.

FIG. 12 is a screenshot illustrating the Find Average Plan.

FIG. 13 is a screenshot illustrating the composition of codes for Find Average Plan

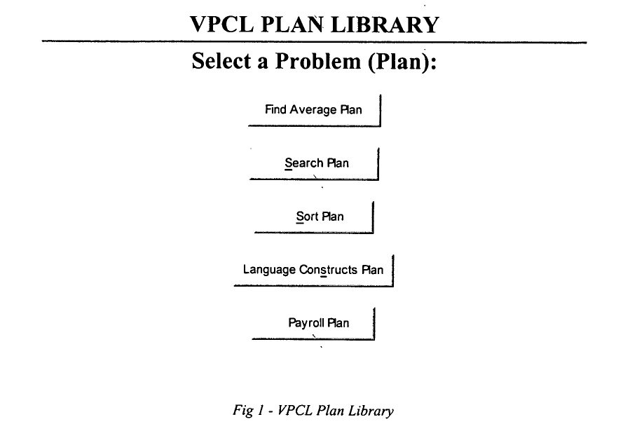

### DETAIL DESCRIPTION OF THE INVENTION

How to Design VPCL from Scratch

1. Put together a library of common problem sets (plans) for novice programmers which include a statistical problem known as find average, find minimum, a search, and sorting problem. In addition, a plan which will address the language constructs. However, the plan library can be extended to include a payroll program as well.

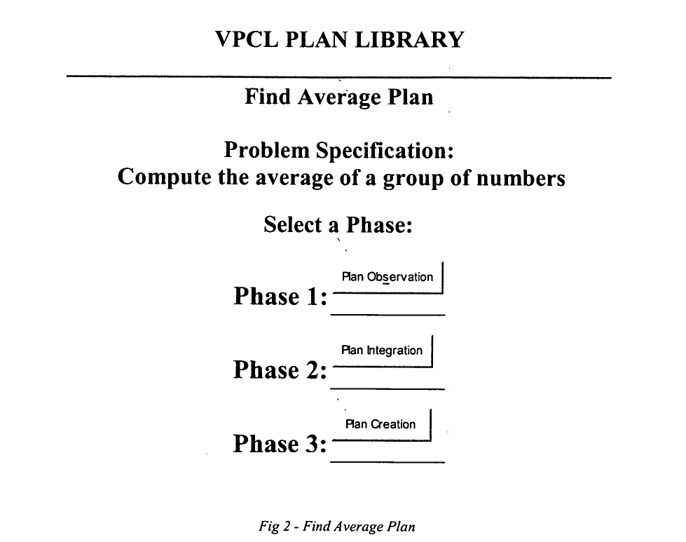

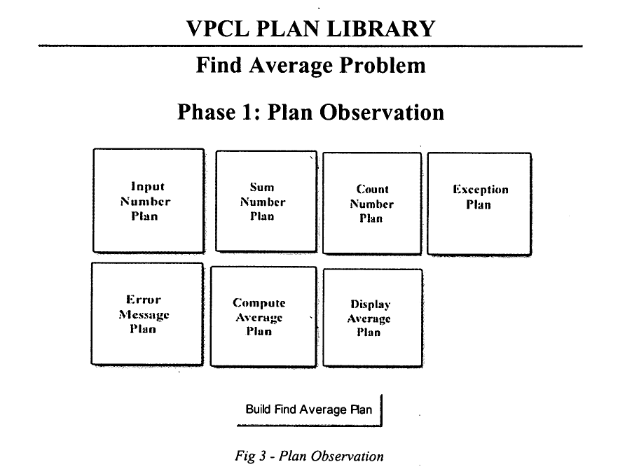

For each problem, associate a picture or draw a box with a title to be clicked. The graphic part of system can be a digital photo, scanned drawing, or created images using graphic software such as Paintbrush. The items to be clicked can be done by hyperlinked button or image. In order to built the system cost effectively and also to be accessible to the educator, HTML with JavaScript is used to specify the plan, connect the plans, to move from one plan to another, and display the programming code as well as demonstrate the output. After a problem plan is selected, a next form prompts the user to select the phase and after the phase is selected the next form displays all of the plans necessary to build the problem plan as illustrated in FIG. 2 and FIG. 3. The main form will have a library of the main plans in conjunction with the following teaching and learning phases.

Breaking the Teaching and Learning Into Three Layers (phases)

2. The plan library includes three phases:
Phase 1—Plan Observation or Rehearsal (Introductory)
Phase 2—Plan Integration or Composition (Intermediate)
Phase 3—Plan Creation or Innovation (Advanced)
   Plan Observation

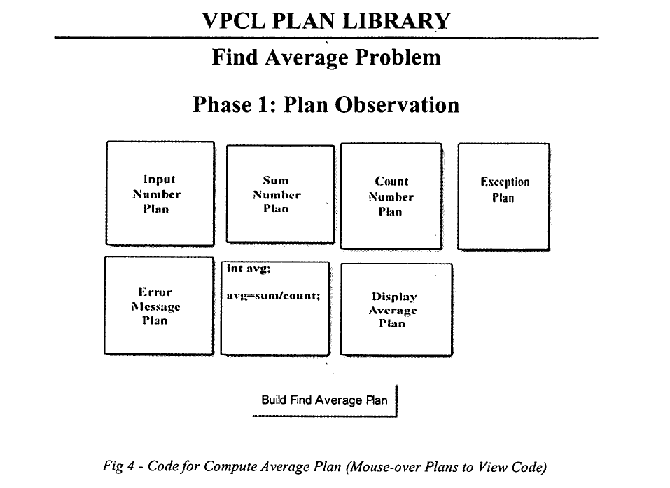

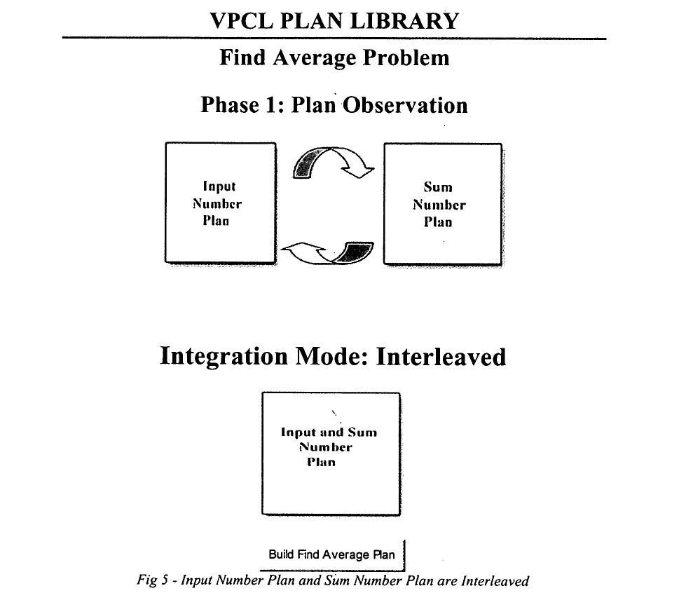

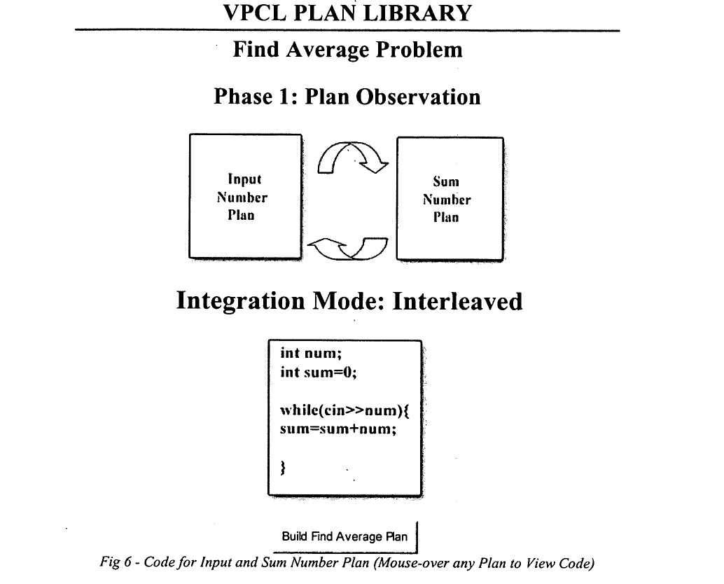

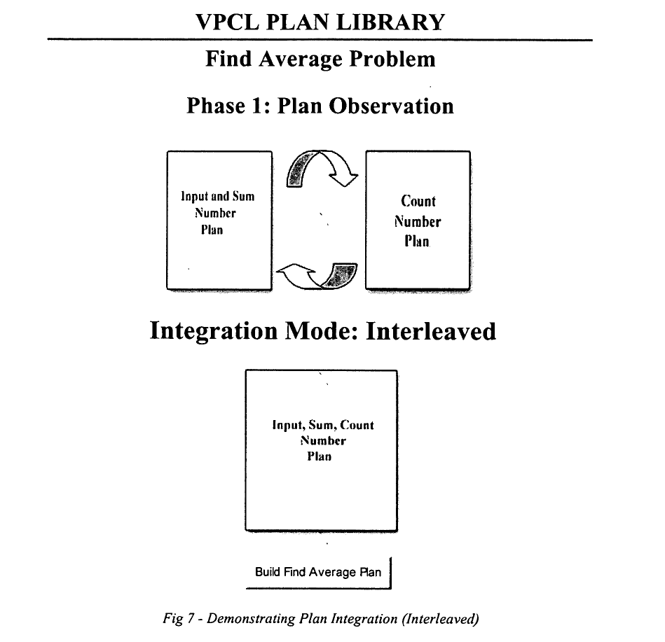

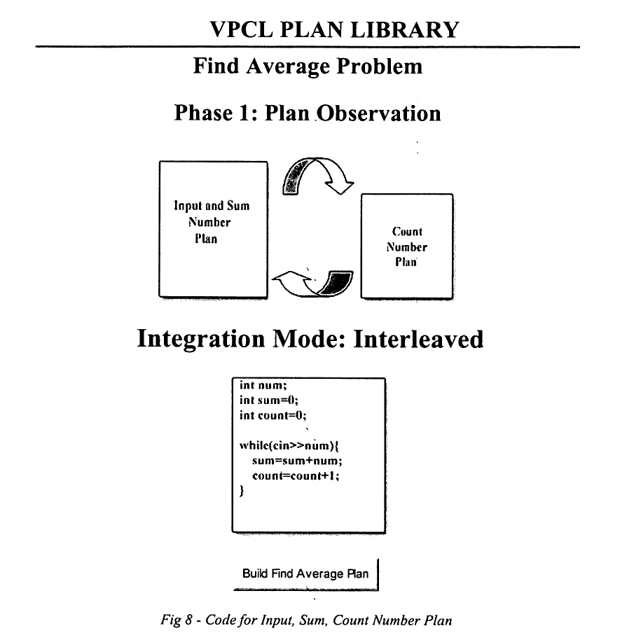

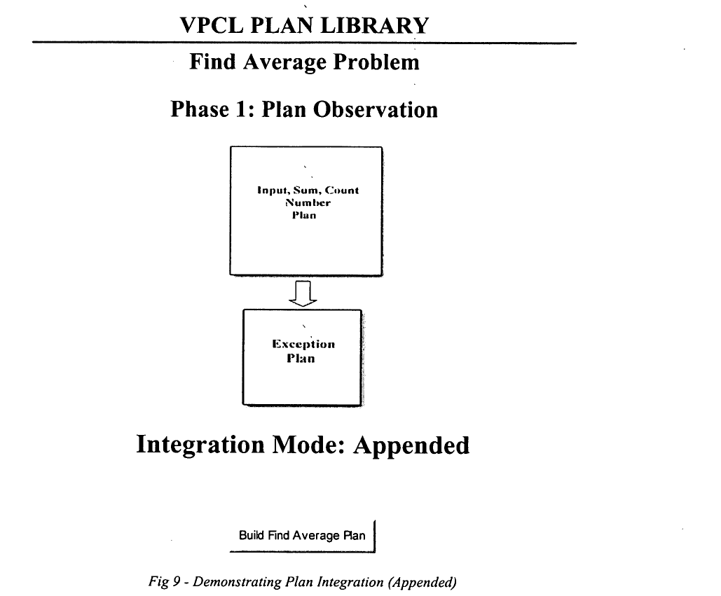

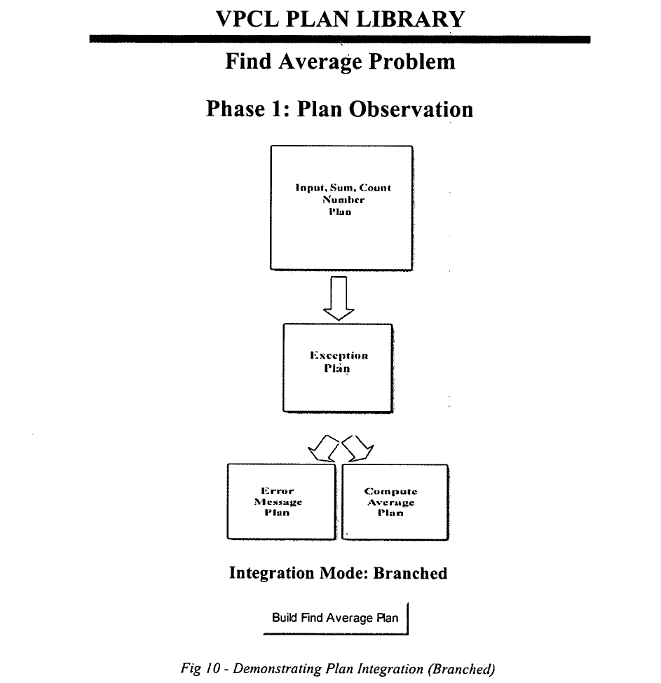

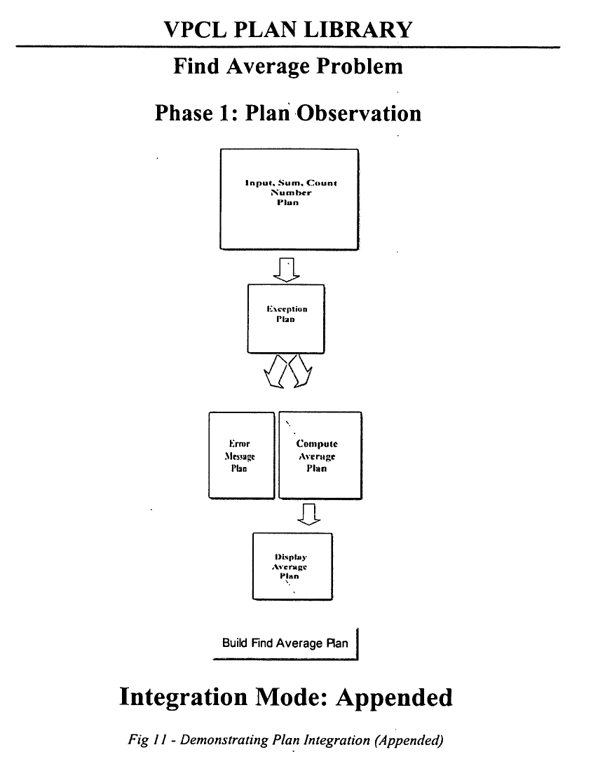

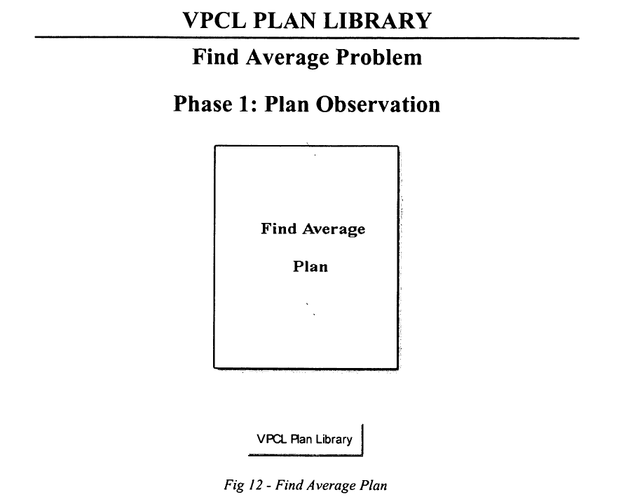

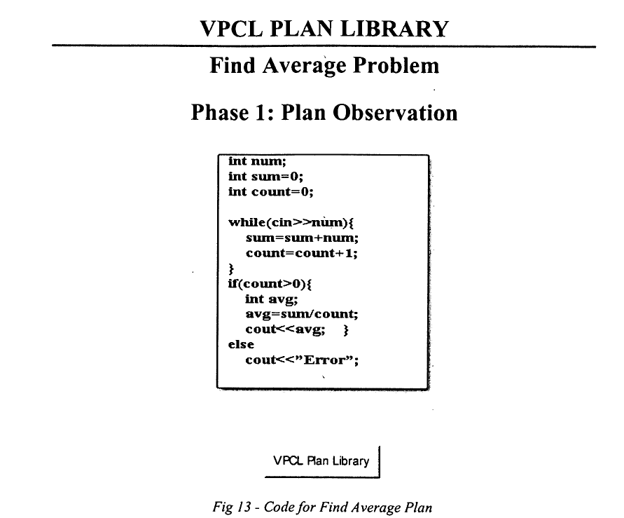

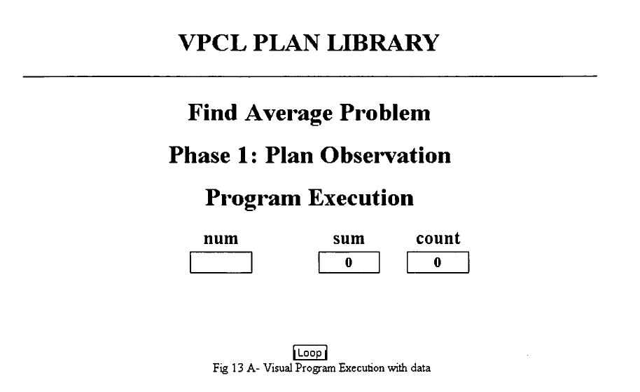

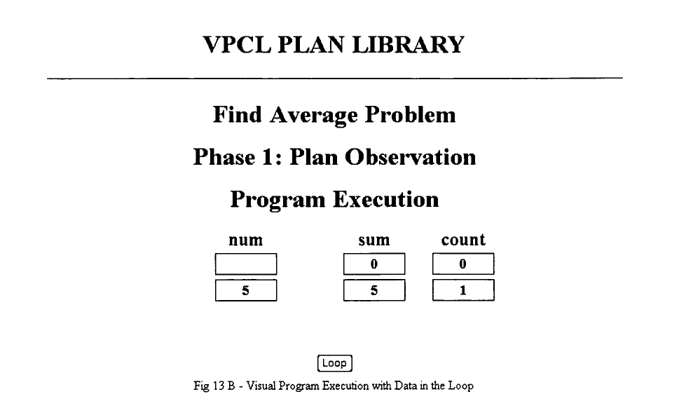

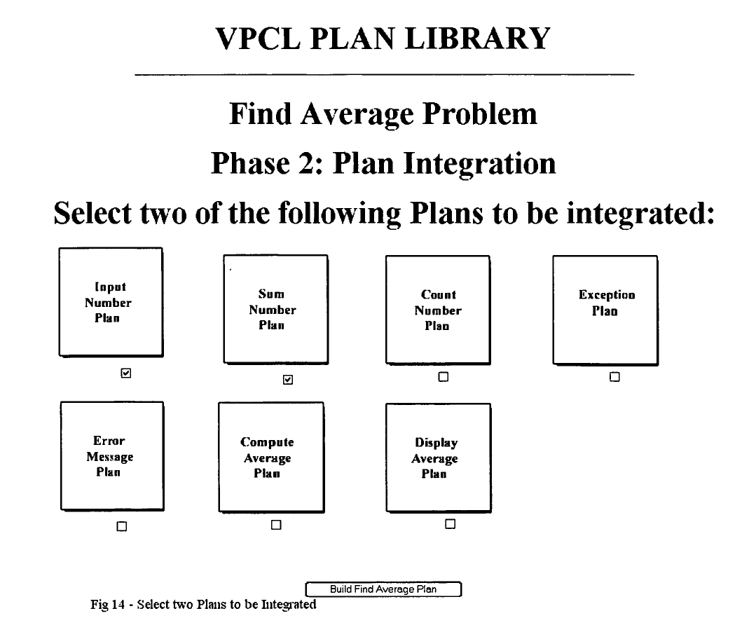

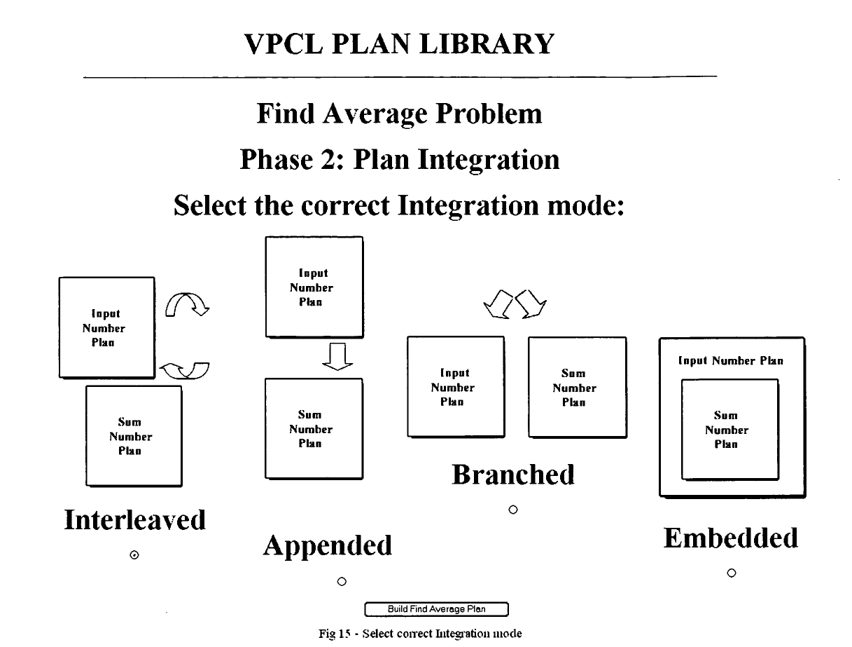

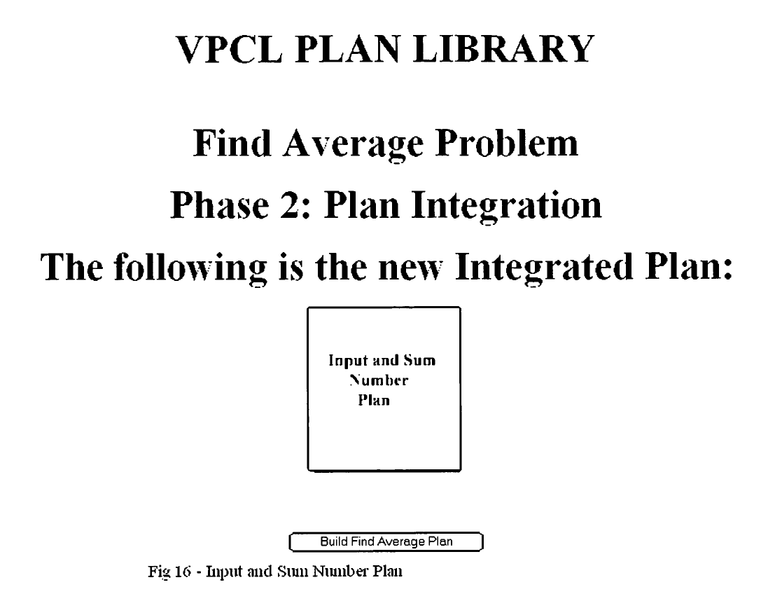

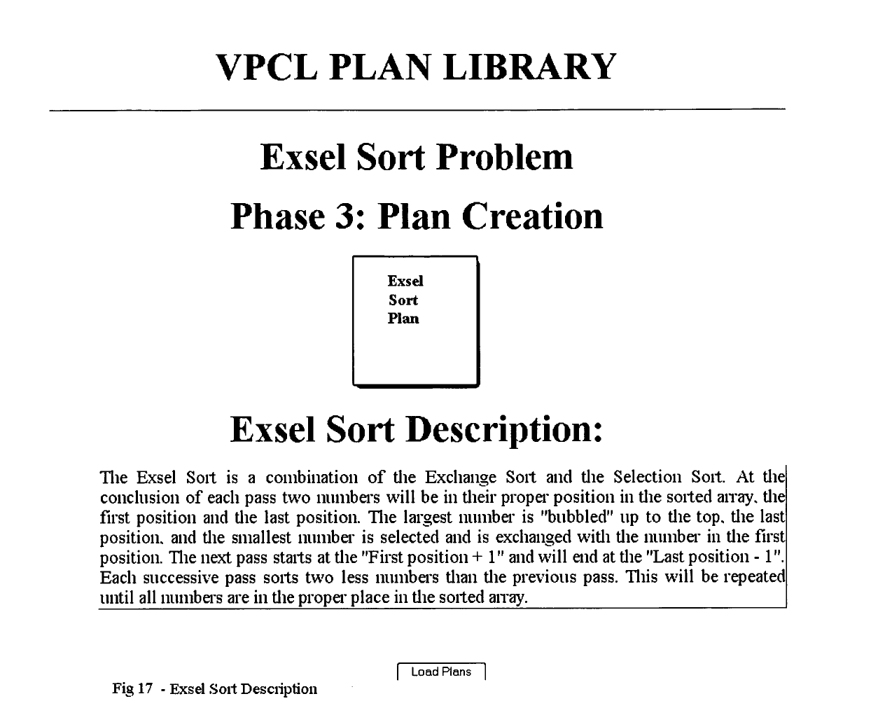

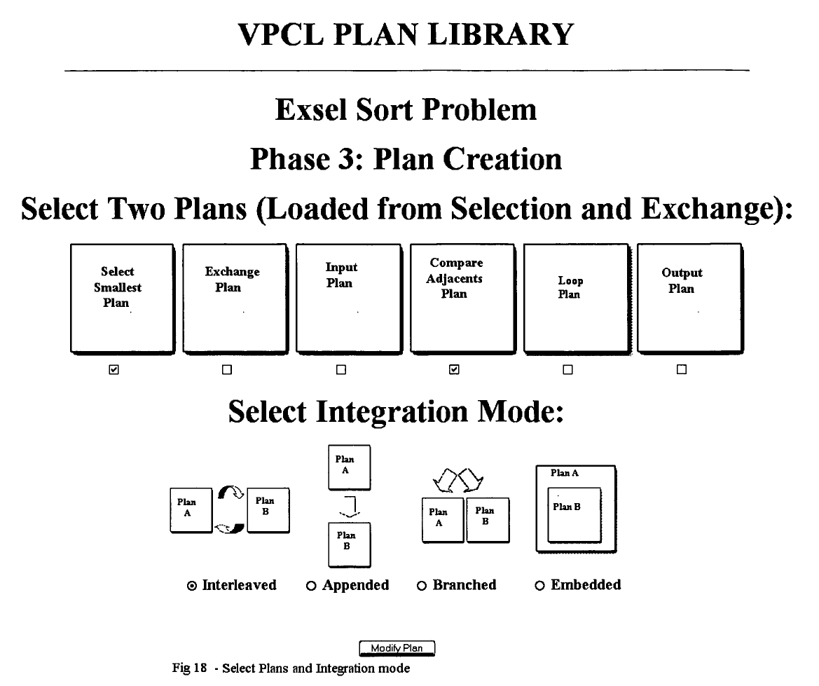

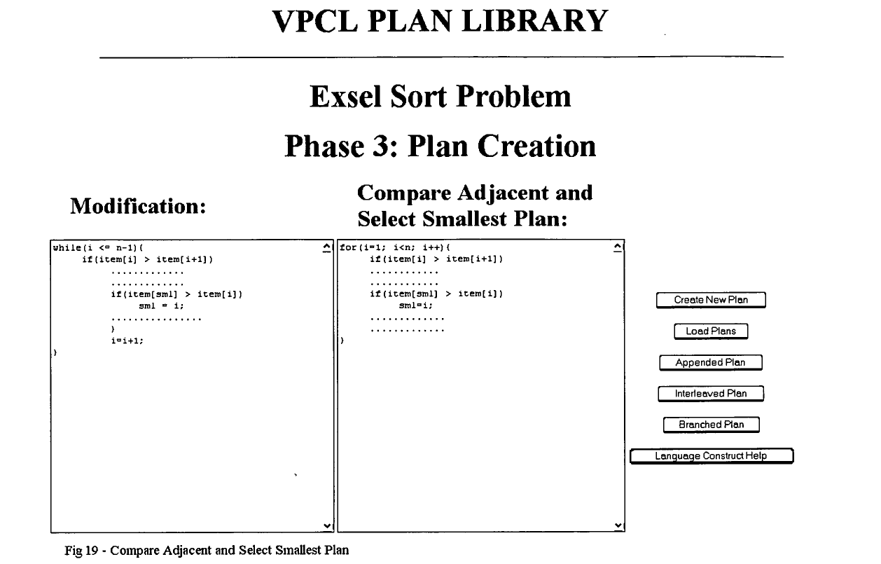

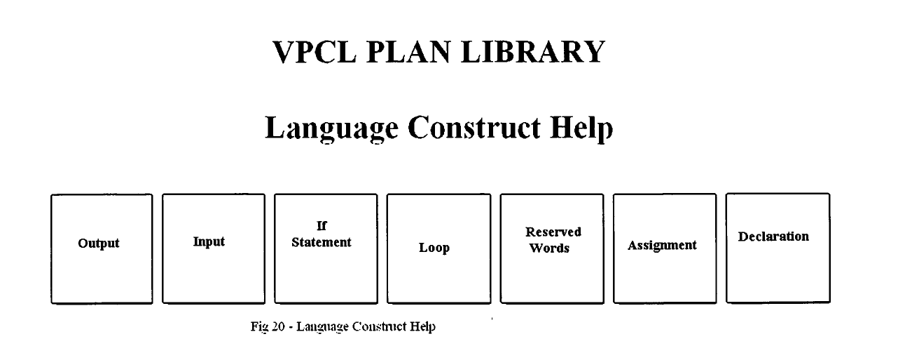

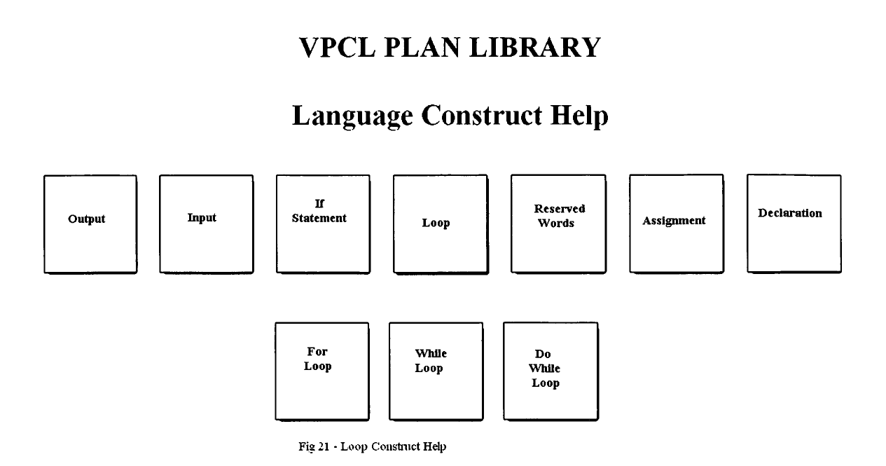

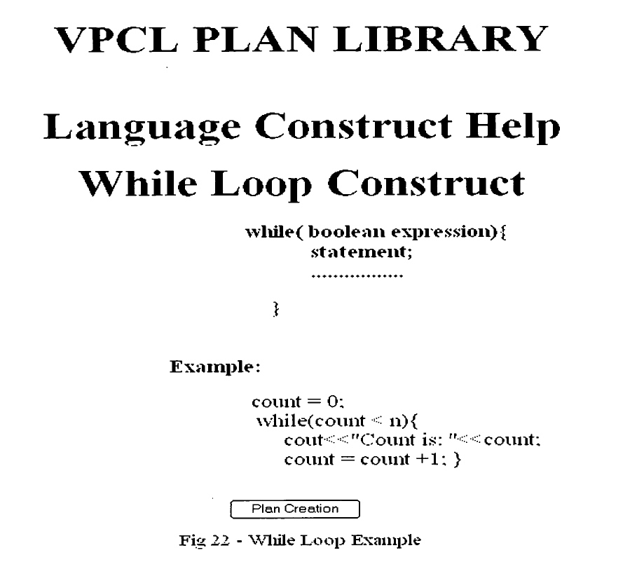

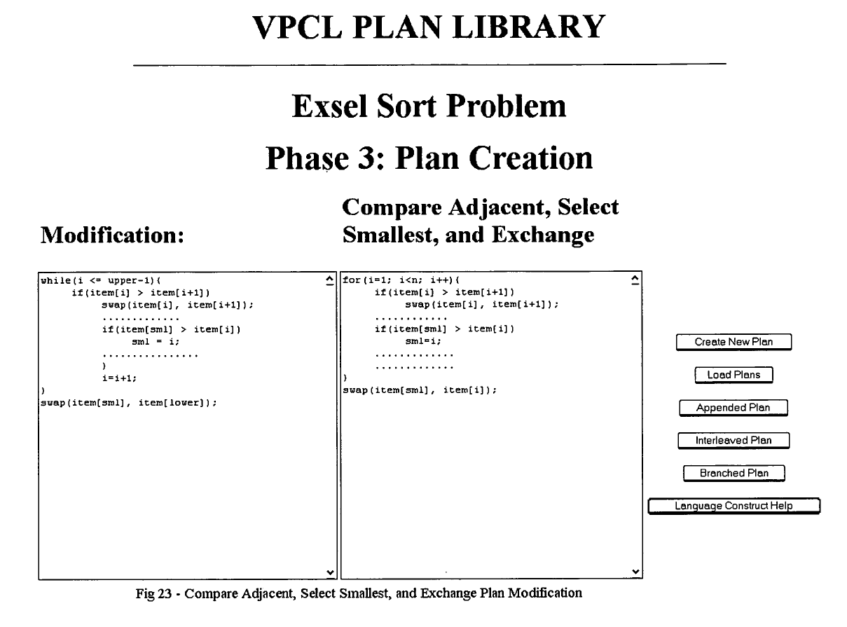

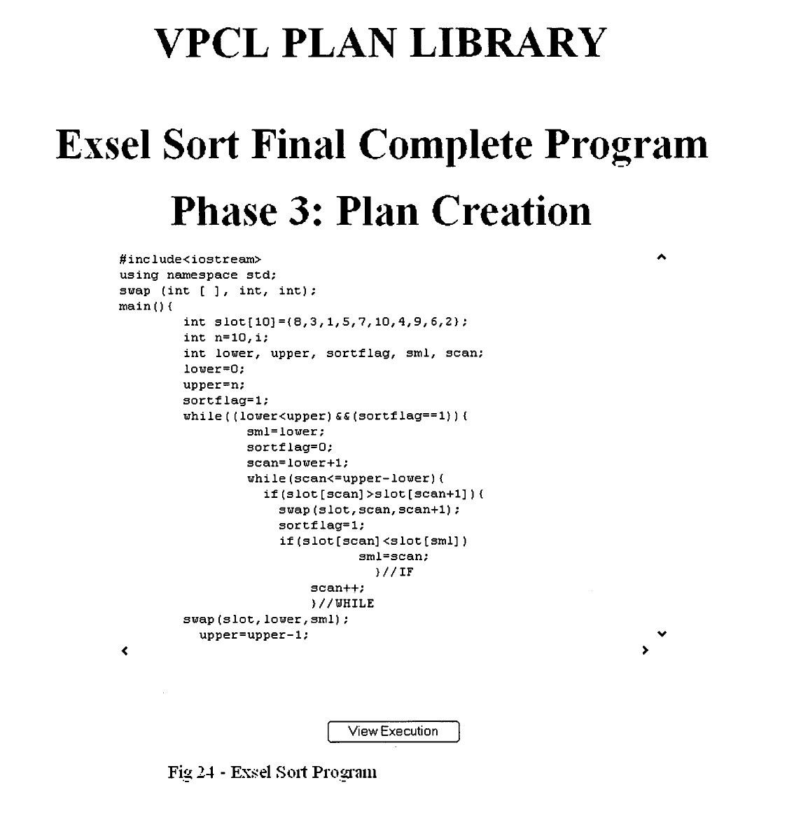

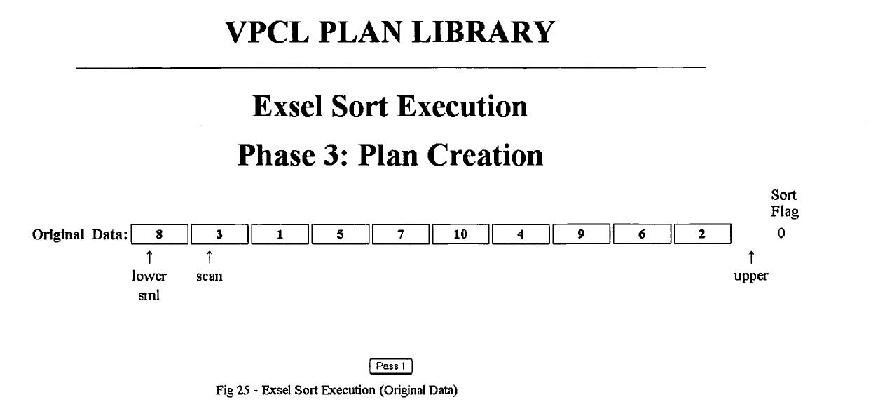

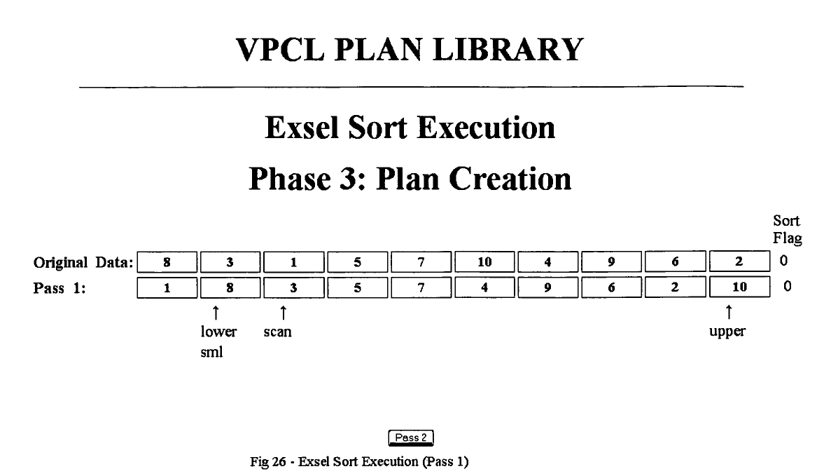

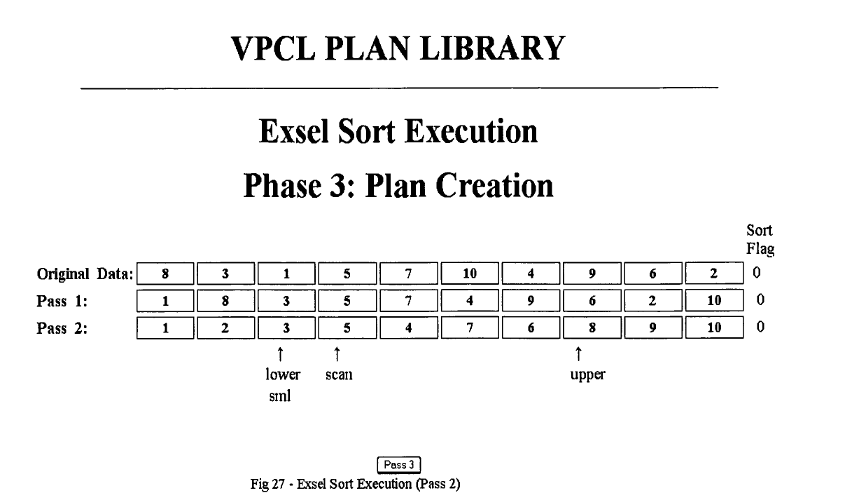

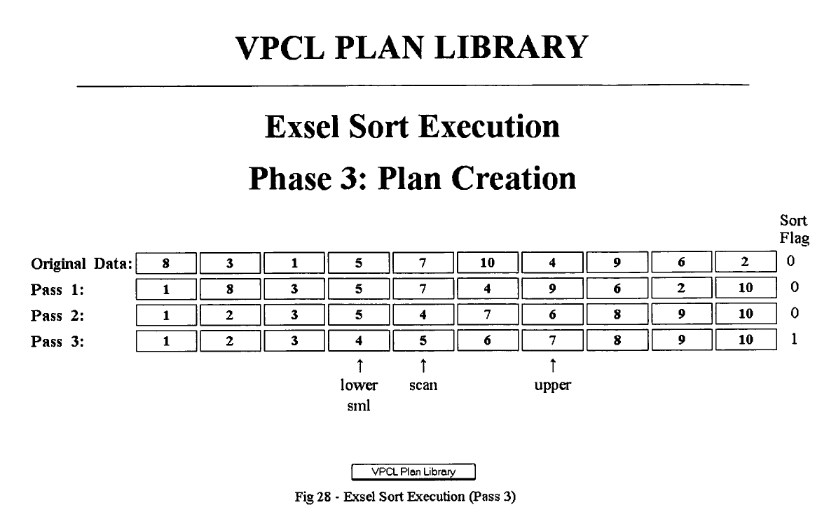

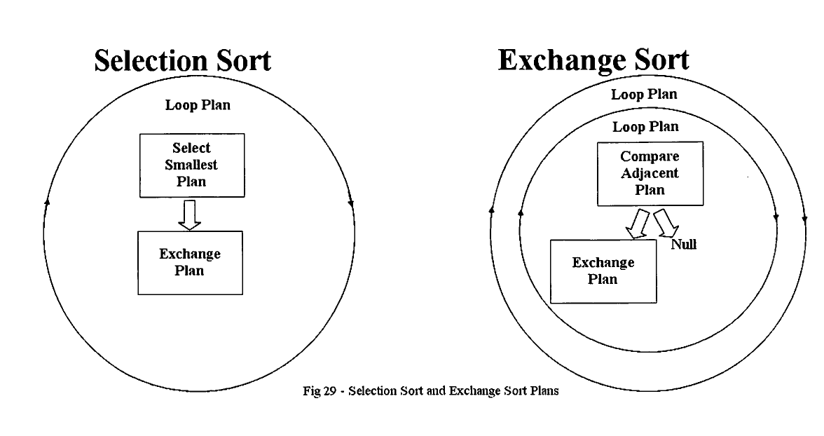

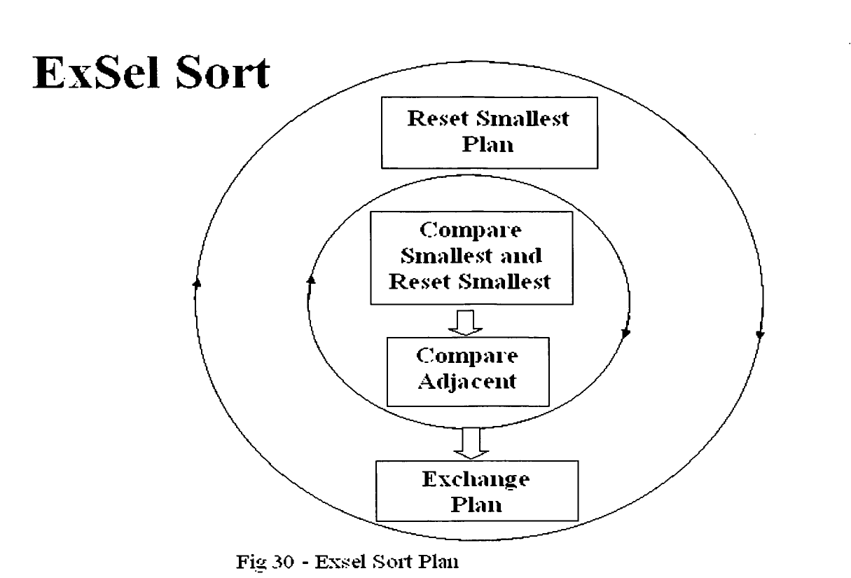

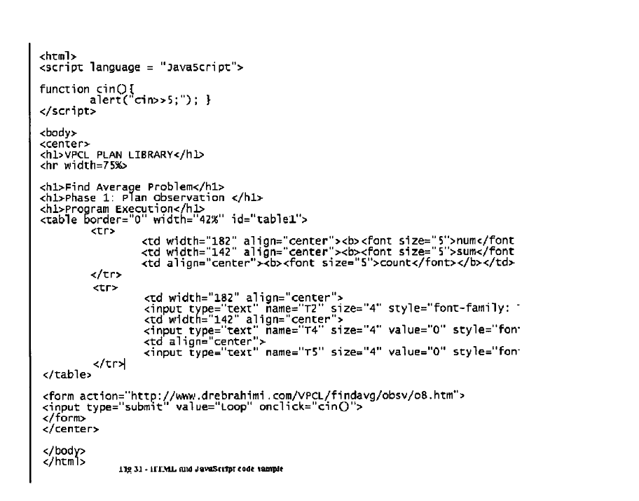

Phase 1 of VPCL is a training and observing phase for learning and teaching a problem to be solved. A novice can observe how a problem is solved and programmed by showing the plans that are needed to build the problem. Forms with a series of predefined plans are illustrated in FIG. 3 and FIG. 4. The Observation Phase also demonstrates how these plans are integrated.

Plan Integration

Every two plans can be integrated according to the following methods. The idea behind plan integration is to focus on the relationship between plans of a problem rather than how a plan is coded at the beginning. 1) A Novice programmer will identify a set of plans for a problem. 2) A Novice programmer will relate two plans at a time by integrating them accordingly to build a bigger plan (new). The integration process will continue until all the plans are connected to build the program. One advantage of working with plans is that by creating layers of abstractions (for example: a plan inside another plan, a plan next to another plan.), the educator or the learner can hide unnecessary details that become overwhelming at the time; the details can be delayed until a proper time.
Appended: When two plans are next to each other (Plan B is after the Plan A)
Embedded: When a plan is inside of another plan. (Plan B is inside Plan A)
Branched: When a plan is in a different branch than another plan (Plan B is in different route than Plan A but coming from the same source.)
Interleaved: When a plan enters and leaves the other plan several times (A statement in Plan B is after a statement in Plan A and so on.)
   Identify Plan Mismanagement and Its Categorization

By focusing on plans and their integration, a problem with programming can be identified at an early stage and be corrected by training rather than at the end by trial and error of input. In addition, a standard will be established that enables an educator and learner to communicate easily with each other as to what has gone wrong and what steps are necessary to correct the problem.
1) Misplaced plan: When a plan is not in its right place. The error category is the most common error among beginner programmers.
2) Malformed plan: When a plan exists but is not totally correct.
3) Missing plan: When a plan is entirely missing in the problem plan set.
4) Misconception plan: When a plan is totally wrong, it may be that some unrelated plan exists whether correct or incorrect.

By focusing on plans and their integration, a problem with programming can be identified at an early stage and be corrected by training rather than at the end by trial and error of input. In addition, a standard will be established that enables an educator and learner to communicate easily with each other as to what has gone wrong and what steps are necessary to correct the problem.

1) Misplaced plan: When a plan is not in its right place. The error category is the most common error among beginner programmers.
2) Malformed plan: When a plan exists but is not totally correct.
3) Missing plan: When a plan is entirely missing in the problem plan set.
4) Misconception plan: When a plan is totally wrong, it may be that some unrelated plan exists whether correct or incorrect.

What is claimed is:

1. A Web-based visual system and progressive method for teaching and learning programming and problem solving, which emphasize on concept of plans, their integrations and standard language construct (agreed vocabulary) to communicate within the system; the system and method is Web Visual Plan Construct Language (Web VPCL).

2. The system of claim 1, wherein Web VPCL consist of a Web Visual library of existing common programming problems and their solutions (main plans).

3. The system of claim 2, comprises three selectable phases known as Observation, Integration, and Creation; the system for introductory, intermediate, and advanced levels.

4. The system of claim 2, wherein Observation phase is selected with a programming plan; the entirety of a solution can be observed, from specification, to plan integration, programming code, visual data execution; thus, it can be visually solved from beginning to end.

5. The system of claim 3, wherein a plan can be partially solved by providing the necessary plans, or newly created from scratch, or by modifying the existing plans.

6. The system of claim 3, wherein Observation phase selected (clicked) and a programming problem plan is chosen from the library.

7. The system of claim 3, wherein the Integration phase is selected the entire plans for a selected programming plan will be displayed.

8. The system of claim 3, wherein Creation phase is selected, a new plan can be created by the modification of existing plans; new plans can also be created from scratch and/or the new plan can be given a name.

9. The method of claim 6, wherein the method for integration of two plans is known as appended when two plans are next to each other; embedded when a plan is inside of another plan; branched when a plan is in a different branch than another plan; or interleaved when a plan enters and leaves the other plan several times.

10. The system of claim 5, wherein two plans will be chosen to be integrated by said integration methods of claim 9.

11. The system of claim 7, wherein two plans can be created preferably by modification of existing plans.

12. The system of claim 7, wherein a new plan can be created by modification of the existing plans; an integration mode will create a new plan automatically and place the programming code into the proper order.

13. Two new plans can be integrated by an integration mode as said in claim 8.

14. A Language Construct help will be provided, so that the educator and learner do not need to concentrate on rote memory which eliminates syntax and semantics errors of particular programming languages.

15. The system as said in claim 12, can be connected to various programming languages to execute various plans; said programming languages such as C/C++, Visual Basic, and Java, Perl, and PHP can be used in execution.

16. The system as said in claim 13, various programming languages can be used to produce the final code in a plan.

17. The system as said in claim 13, various programming languages can be used for the execution of plans.

18. The system as said in claim 13, various programming languages can be used for the testing of plans.

19. A progressive method as recited in claim 1, of teaching and learning and programming problem solving based on the web, visualization, plan, a built-in standard language construct, and a web-based library of plans consisting of common problems, which can be grown or shrunk.

20. The method as recited in claim 2, Web VPCL consists of three selectable phases of problem solving:
Observation or Rehearsal (Introductory level);
Integration or Composition (Intermediate level);
Creation or Innovation (Advanced level).

21. The method as recited in claim 18, wherein observation phases is a Web animated process, illustrates the steps involved in programming from the initial specification of the problem, to the final execution in programming with data for training purposes for the user.

22. The method, as recited in claim 18, is the, the Integration phase wherein the user is trained in the process of putting the plans together by providing the necessary sets of plans for a problem, requiring the user to select two plans from the set at each time and identify spatial relationships.

23. The method as recited in claim 20, entails four integration modes knows as appended, embedded, interleaved, branched; whereby the user then utilizes the methods of integration; Two plans are joined together by their relationship in solving the bigger problem and finally the solution of the problem.

24. The method as recited in claim 21, trains the user to select proper integration mode, each time until the entire integration is completed to a full plan; and in the case of an improper integration of two plans the user can retry the integration mode or return to the observation phase page to learn how to integrate plans.

25. The method of said plan wherein a correct combination of two plans with a specific integration mode will result to a new plan than can be integrated with the existing plan.

26. The method as recited in claim 22, after plans are connected correctly the user progressively observes the problem solving steps and programming creation.

27. The method as recited in claim 18, the creation phase, deals with the creation of plans and the writing of actual code in a web workspace of Web VPCL; this promote reusability of or modification of existing plans of web plans.

28. The method as recited in claim 18, wherein a plan can be selected from the web-based library for modification or created from scratch where the code and execution
